(19) United States
(12) Patent Application Publication
(10) Pub. No.: US 2014/0365291 A1
(43) Pub. Date: Dec. 11, 2014

(54) UNIVERSAL LOYALTY PROGRAM

(71) Applicant: Rawllin International Inc., Tortola (VG)

(72) Inventor: Simon Shvarts, San Jose, CA (US)

(21) Appl. No.: 13/913,778

(22) Filed: Jun. 10, 2013

(51) Int. Cl. G06Q 30/02

(52) U.S. Cl. CPC G06Q 30/0233
USPC 705/14.33; 705/14.27

(57) ABSTRACT

The performance of obligations is facilitated with respect to a discount received via a loyalty program. For example, the performance of the obligations can be facilitated via: managing information regarding the obligation of a user of the loyalty program; determining a path to satisfaction of the obligation based on a location of a mobile device associated with the user; and producing a notification regarding fulfillment of the obligation based on the path.

### TECHNICAL FIELD

The subject application relates generally to a loyalty program and more particularly to the facilitation of performance of obligations toward satisfaction of a commitment related to the loyalty program.

### BACKGROUND

A loyalty program is a structured marketing effort rewarding a member of the loyalty program for loyal buying behavior. By presenting an indication of membership in the loyalty program (e.g., a credit card) at a point a sale, the purchaser is entitled to a discount on the current purchase or to an allotment of points that can be used for a discount on a future purchase. The reward encourages the member to buy products and/or services from the sponsor of the loyalty program or a merchant with connections to the loyalty program. In turn, the sponsor of the loyalty program or the merchant with connections to the loyalty program benefits from the loyal buying behavior at least as a source for market research or client development.

Loyalty programs exist in many different forms. A rudimentary example of a loyalty program is a punch card that is presented upon a purchase, and a certain number of punches of the card leads to a reward (e.g., “buy 4 cups of coffee, get the 5^{th} free”). A more sophisticated example of a loyalty program is a credit card loyalty system that rewards points for using the card at certain venders or combinations of vendors within a network of vendors.

Many of these loyalty programs, however, do not provide a sufficient mechanism to ensure that the discounts earned within the loyalty programs are used. Often the member of the loyalty program allows certain discounts to lapse without completion of all of the requirements of the loyalty program. Accordingly, the sponsor of the loyalty program or the merchant with connections to the loyalty program does not achieve the benefits associated with the loyalty program.

The above-described deficiencies of conventional loyalty programs are merely intended to provide an overview of some of problems of current technology, and are not intended to be exhaustive. Other problems with the state of the art and corresponding benefits of some of the various aspects and embodiments described herein may become further apparent upon review of the following detailed description.

### SUMMARY

The following presents a simplified summary in order to provide a basic understanding of some aspects of the universal loyalty program applications disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various aspects and embodiments are described herein that can facilitate the performance of obligations with respect to a discount received via a loyalty program. The aspects and embodiments herein can be implemented in connection with any type of device with a connection to a communications network (e.g., a wireless communications network, the Internet, or the like), such as a mobile handset, a computer, a handheld device, or the like. The aspects and embodiments can also be employed, for example, by one or more servers in a cloud computing environment.

According to an embodiment, described herein is a system that can facilitate satisfaction of an obligation, commitment or requirement related to a discount awarded in connection with a loyalty program. The system includes a memory to store instructions and a processor, coupled to the memory, that facilitates execution of the instructions. The execution of the instructions can lead to operations, including: managing information regarding a obligation, commitment or requirement of a user of the loyalty program; determining a path to satisfaction of the obligation, commitment or requirement based on a location of a mobile device associated with the user; and producing a notification regarding fulfillment of the obligation, commitment or requirement based on the path.

In another embodiment, a mobile device is described that can facilitate satisfaction of an obligation, commitment or requirement related to a discount awarded in connection with a loyalty program. The mobile device includes a memory to store instructions and a processor, coupled to the memory, that facilitates execution of the instructions. The execution of the instructions can lead to operations, including: publishing information related to a discount related to the loyalty program and an obligation, commitment or requirement related to the discount; receiving an input from a user accepting the discount and the obligation, commitment or requirement; crediting the user with the discount; linking the obligation, commitment or requirement to an account related to the loyalty program and associated with the user; and publishing a notification to the user related to satisfaction of the obligation, commitment or requirement.

In a further embodiment, a method that can be executed by a system or device comprising a processor is described herein. The method can facilitate satisfaction of an obligation, commitment or requirement related to a discount awarded in connection with a loyalty program. The method includes: receiving first information related to a first discount from a first merchant and second information related to a second discount from a second merchant; aggregating the first information related to the first discount from the first merchant and the second information related to the second discount from the second merchant into a package; linking an obligation, commitment or requirement with the package, wherein the obligation, commitment or requirement is determined based on the first discount and the second discount and the requirement comprises an amount to be spent by a deadline; and offering the package linked with the obligation, commitment or requirement to a user.

In yet another embodiment, a computer storage device is described. The computer readable storage device comprises computer-executable instructions that, in response to execution, cause a system comprising a processor to perform operations that can facilitate satisfaction of an obligation, commitment or requirement related to a discount awarded in connection with a loyalty program. The operations include offering a discount toward a purchase from a merchant and an obligation, commitment or requirement to satisfy before expiration of a time period; receiving an indication of acceptance of the discount and the obligation, commitment or requirement of an additional amount to be spent from the user; applying the discount toward the purchase upon receiving the indication of acceptance; and tracking an amount spent by the user towards satisfaction the additional amount to be spent of the obligation, commitment or requirement by the deadline.

The following description and the annexed drawings set forth in detail certain illustrative aspects of the disclosed subject matter. These aspects are indicative, however, of but a few of the various ways in which the principles of the various aspects and embodiments may be employed. The disclosed subject matter is intended to include all such aspects and their equivalents. Other advantages and distinctive features of the disclosed subject matter will become apparent from the following detailed description of the various aspects and embodiments when considered in conjunction with the drawings.

### BRIEF DESCRIPTION OF THE DRAWINGS

Non-limiting and non-exhaustive aspects and embodiments of the subject disclosure are described with reference to the following figures, wherein like reference numerals refer to like parts throughout the various views unless otherwise specified.

FIG. 1 illustrates a schematic block diagram of an example cloud computing system, in accordance with various aspects described herein;

FIG. 2 illustrates a schematic block diagram of an example system that can facilitate determination of a path to fulfill an obligation related to a discount received in connection with a loyalty program, in accordance with various aspects described herein;

FIG. 3 illustrates a schematic block diagram of example factors that can utilized by the path component in the determination of the path to fulfill the obligation related to the discount received in connection with the loyalty program, in accordance with various aspects described herein;

FIG. 4 illustrates a schematic block diagram of an example notification that can be produced by the notification component, in accordance with various aspects described herein;

FIG. 5 illustrates a schematic block diagram of an example operation of the manager component with regard to an unsatisfied commitment, in accordance with various aspects described herein;

FIG. 6 illustrates a schematic process flow diagram of a method that can facilitate determination of a path to fulfill an obligation related to a discount received in connection with a loyalty program, in accordance with various aspects described herein;

FIG. 7 illustrates a schematic process flow diagram of a method that can facilitate satisfaction of an outstanding obligation, in accordance with various aspects described herein;

FIG. 8 illustrates a schematic block diagram of a system that can facilitate a user's registration for a discount and commitment with regard to a loyalty program, in accordance with various aspects described herein;

FIG. 9 illustrates a schematic block diagram of examples of displays of offers of discounts associated with obligations that can be published by the publication component, in accordance with various aspects described herein;

FIG. 10 illustrates a schematic block diagram of a further example of a display of offers of discounts associated with obligations that can be published by the publication component, in accordance with various aspects described herein;

FIG. 11 illustrates a schematic block diagram of a system that facilitates tracking of a deadline associated with the satisfaction of the obligation associated with the discount, in accordance with various aspects described herein;

FIG. 12 illustrates a schematic block diagram of a system that can facilitate establishment of a new deadline for an outstanding obligation, in accordance with various aspects described herein;

FIG. 13 illustrates a schematic process flow diagram of a method to facilitate a user's registration for a discount and commitment with regard to a loyalty program, in accordance with various aspects described herein;

FIG. 14 illustrates a schematic process flow diagram of a method that can facilitate extension of a deadline of an outstanding obligation, in accordance with various aspects described herein;

FIG. 15 illustrates a schematic block diagram of a system that facilitates aggregation of different discounts in a package with one or more obligations, in accordance with various aspects described herein;

FIG. 16 illustrates a schematic block diagram of a system that can track progress in satisfying an obligation, in accordance with various aspects described herein;

FIG. 17 illustrates a schematic process flow diagram of a method that can aggregation of different discounts in a package with one or more obligations, in accordance with various aspects described herein;

FIG. 18 illustrates a schematic process flow diagram of a method that can facilitate tracking purchases for satisfaction of a requirement, in accordance with various aspects described herein;

FIG. 19 illustrates a schematic process flow diagram of a method that can facilitate extension of a deadline of an outstanding obligation, in accordance with various aspects described herein;

FIG. 20 illustrates a schematic block diagram of an example mobile device that can employ services that facilitate the performance of obligations to satisfy a commitment related to the loyalty program in accordance with the aspects and embodiments described herein; and

FIG. 21 illustrates a schematic block diagram of an example computer operable to execute a system architecture that facilitates implementations of services that facilitate the performance of obligations to satisfy a commitment related to the loyalty program according to the aspects and embodiments described herein.

### DETAILED DESCRIPTION

In the following description, numerous specific details are set forth to provide a thorough understanding of the aspects and embodiments of the subject disclosure. One skilled in the relevant art will recognize, however, that the aspects and embodiments described herein can be practiced without one or more of the specific details, or with other methods, components, materials, etc. In other instances, well-known structures, materials, or operations are not shown or described in detail to avoid obscuring certain aspects.

According to an aspect of the subject disclosure, a loyalty program is described herein. The loyalty program can employ various mobile applications or services that can facilitate of performance of obligations to satisfy a commitment of a user related to the loyalty program. The loyalty program or “universal loyalty program” is generally a platform that can partner with banks, who issue a particular member identification indication (e.g., a credit card) in connection with the universal loyalty program. Merchants agree to participate in the loyalty program or to partner with other merchants within the loyalty program to offer various discounts in exchange for a promise by the user to spend an additional amount either at the merchant or at a partner merchant. The promise to spend the additional amount is generally referred to in this application as a requirement, a commitment, or an obligation; these terms are used interchangeably throughout this application.

The provider of the loyalty program platform (“platform” or “loyalty program platform”), the bank, and the various merchants can share a profit from sales related to the loyalty program. For example, the loyalty program platform can receive x % of all sales related to obligations of the loyalty program. The platform can split the percentage between itself and the associated bank. If a user does not satisfy the commitment, the loyalty program can, for example, keep the amount of the discount taken from the user's account and split it with the bank and the merchant, accordingly. The platform assumes the risk that the account will be unable to pay back the discount.

As a practical example, the loyalty program can be utilized at a point of purchase as follows. At the point of purchase, a user of the loyalty program can present a member identification indication before the purchase is undertaken. Upon display of the member identification indication, the user can be presented with an immediate discount that is coupled with a requirement to spend an additional amount by a deadline. If the user chooses to take advantage of the immediate discount at the point of purchase, he becomes obligated to fulfill the requirement to spend the additional amount by the deadline. If the user fails to fulfill the requirement to spend the additional amount by the deadline, an amount of the given discount can be returned to the merchant from the user.

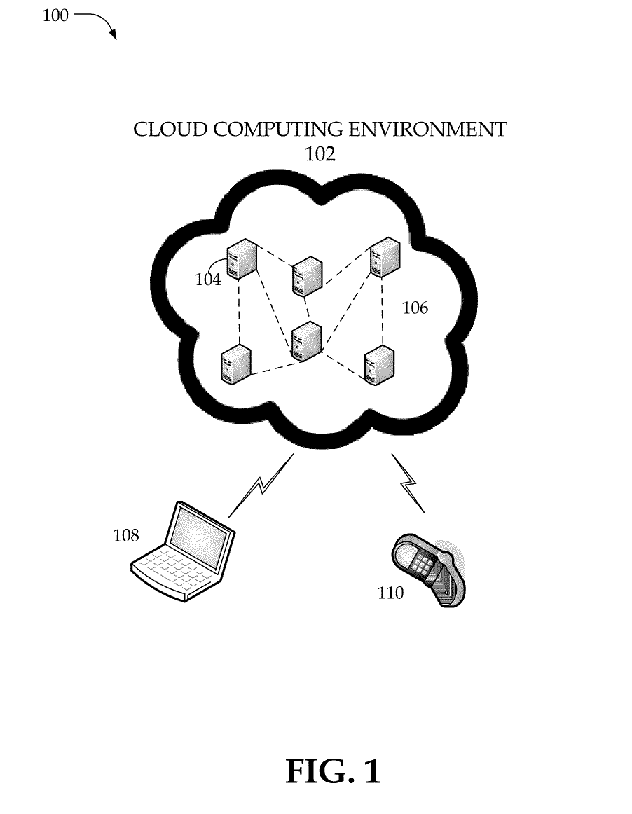

The loyalty program can be linked to a mobile application or service that can facilitate satisfaction of the requirement by the deadline. The mobile application or service can be executed on different mobile devices. Generally the term mobile device refers to any type of small, handheld computing device. The mobile device often has a display screen with a means for input (touch screen, keyboard, or the like). Examples of mobile devices are shown in FIG. 1 and include a laptop computer 108, a mobile phone 110, a smart phone, a tablet computing device, or any other mobile computing device.

The mobile application or service can be stored locally within the mobile computing device or remotely within a cloud computing environment 102. Within the cloud computing environment, the mobile application or service can be stored on a single server 104 or within a network of servers 106. In this case, the mobile computing devices can access the service via a public network, such as the Internet, or a private network, eliminating the need for the mobile application or service to be stored locally on the various computing devices.

The mobile application or service can be expressed as systems that can employ components. As utilized herein, terms “application,” “service,” “system,” “component,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

In addition, the mobile application or service can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable device. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable devices.

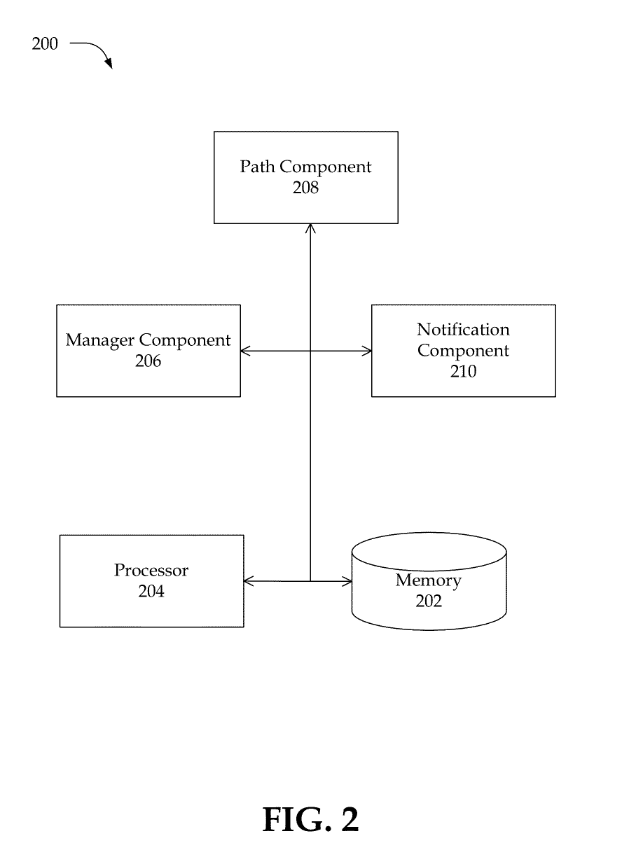

Referring now to FIG. 2, illustrated is a schematic block diagram of an example system 200 that can facilitate determination of a path to fulfill an obligation related to a discount received by a user in connection with a loyalty program, in accordance with various aspects described herein. System 200 includes a memory 202 that can store instructions, components, or the like. System 200 also includes a processor 204 that can facilitate execution of the instructions, components, or the like to facilitate the performance of various operations associated with the instructions, components, or the like. System 200 can be employed as a mobile application that is stored on a mobile device or a service that is stored in a cloud computing environment. In the case of the system 200 being stored on a mobile device, the memory 202 and processor 204 can be the memory and processor of the mobile device. In the case of the system 200 being stored within a cloud computing environment, the memory can be associated with a server or distributed across a plurality of servers within the cloud computing system, accessed via a network, and executed by a processor of a mobile device. Additionally, system 200 can be both stored and executed within the cloud computing environment.

System 200 includes various components that can facilitate determination of a path to fulfill an obligation (commitment, requirement, or the like) related to a discount received in connection with a loyalty program. The loyalty program can provide an on the spot discount at a point of purchase. The discount can be bundled with an obligation to spend an additional amount before expiration of a deadline. If the obligation is not fulfilled by the deadline, the user can be required to repay the amount of the discount from the account. System 200 can facilitate fulfillment of the obligation by the deadline.

For example, system 200 can include a manager component 206, a path component 208 and a notification component 210 that are each stored in the memory 202 and execution is facilitated by the processor 204. The manager component 206 can manage information regarding a commitment of a user of the loyalty program (e.g., amount required to spend, amount currently spent, deadline, merchant location(s), user account information, etc.). The path component 208 can determine a path to satisfaction of the commitment based on a location of a mobile device associated with the user. The notification component 210 can produce a notification regarding fulfillment of the commitment based on the path.

The notification produced by the notification component 210 can show indications of one or more merchants the user of the loyalty program is currently engaged with (in other words, “has one or more outstanding obligations to”). The path component 208 can facilitate a determination of a path to satisfaction of the one or more outstanding obligations. The manager component 206 can track how much more needs to be spent at the one or more merchants to satisfy the one or more outstanding obligations, as well as how much has already been spent. Accordingly, the notification component 210 can utilize information from the path component 208 and the manager component 206 to produce the notification. For example, the notification can include an amount of time to the deadline, location of one or more merchants, proximity to one or more merchants, and other ways to satisfy the obligation within the deadline.

The terms “commitment,” “requirement,” and “obligation” generally refer to a contractual obligation in connection with the loyalty program. The user of the loyalty program agrees to the obligation in exchange for a discount at the point of purchase. Generally, the obligation is for future purchases, but the future purchases can also occur at the same time as the discount is awarded. The obligation can include any combination of money that must be spent at any combination of merchants using the loyalty program before expiration of one or more deadlines. In an example, the obligation can be related to an amount of money that must be spent at the merchant granting the discount using the loyalty program before expiration of a deadline. The obligation, in another example, can be related to an amount of money that must be spent at a different merchant that does not grant the discount using the loyalty program before expiration of a deadline.

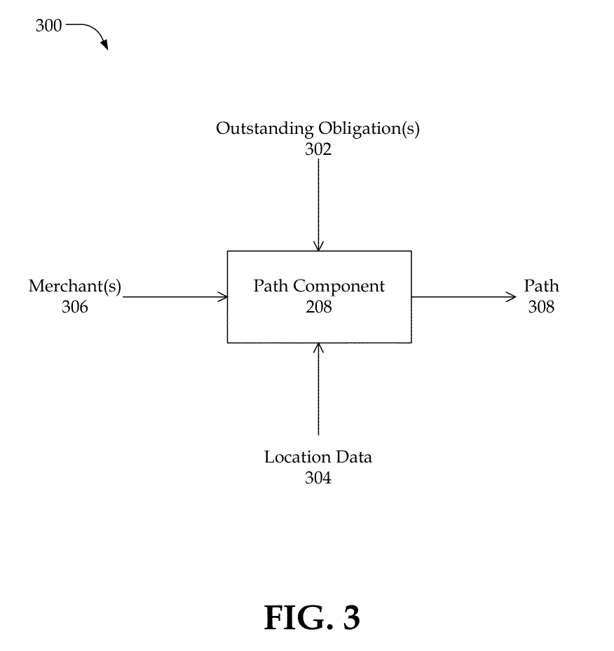

As shown in FIG. 3, the path component 208 can facilitate satisfaction of one or more outstanding obligations 302 before the associated deadlines. The path component can utilize information about any outstanding obligations 302, data about the location of the mobile device associated with the user (location data 304), and data about the locations of the merchant(s) 306 associated with the obligation to produce one or more paths 308 to satisfaction of the outstanding obligation(s) 302.

The path component 208 can examine one or more of the outstanding obligations 302. The path component 208 can take into account deadlines associated with the various outstanding obligations 302 and rank the outstanding obligations 302 according to a priority associated with the deadlines. For example, the outstanding obligation with the closest deadline can be awarded the highest priority.

The path component 208 can also analyze location data 304 associated with the mobile device associated with the user. The user location data 304 can be analyzed in connection with the merchant 306 location data. The user location data 304 can be determined by geolocation data that can be analyzed to determine the location data 304. The geolocation data can be associated with global positioning satellite data, cell tower triangulation data, or any other type of geolocation data. The merchant 306 location data is unchanging, so it can be gathered from a map, or the like.

When the user is determined to be in a location near one or more merchants 306 connected to one or more outstanding obligations 302, the path component 208 can create a path 208 to satisfaction of the obligation. Multiple paths 308 can be connected with multiple different outstanding obligations 302. Multiple paths 308 can also be created that show different ways to satisfy different outstanding obligations 302. The path can be further determined based on the priority associated with various deadlines associated with different outstanding obligations.

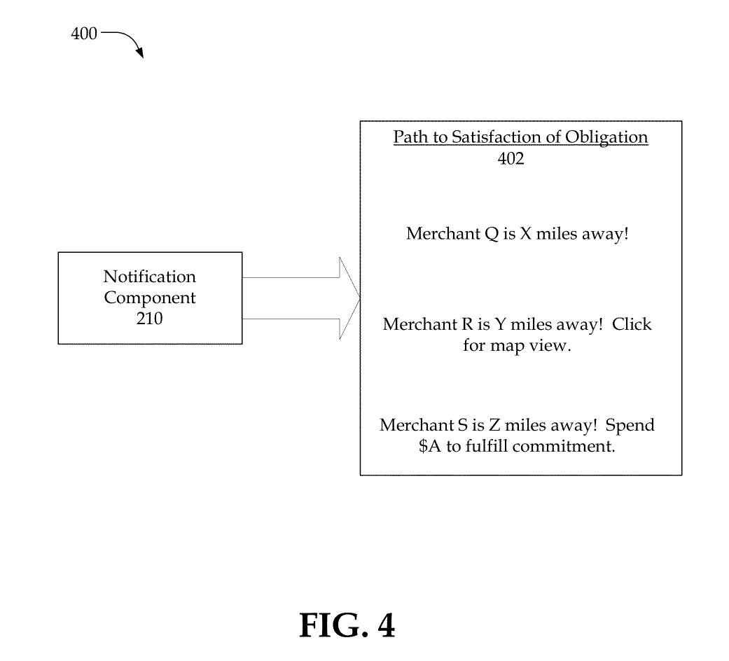

The path 308 can be displayed as a notification 402 produced by the notification component 210. Example notifications 402 that can be produced by the notification component 210 are shown in greater detail in FIG. 4. The notification 402 (or any one of the listed notifications within notification 402) can be displayed on a screen of a mobile device. The notification can be sent as a text notification to the mobile device—for example, a push notification on the mobile device or a SMS message (used interchangeably with text message) to the user of the mobile device. As shown in notification 402, the text can indicate a location of a merchant that can be used to satisfy one or more obligations.

The notification component 210 can provide a way to select the path to the merchant. Upon selection of the path to the merchant, the notification component 210 can provide a mapping functionality that can utilize a map application on the mobile device to draw the path on the map. The notification component 210 can facilitate the drawing of multiple paths on the map at a time to facilitate the satisfaction of multiple obligations based on a location of the mobile device associated with the user.

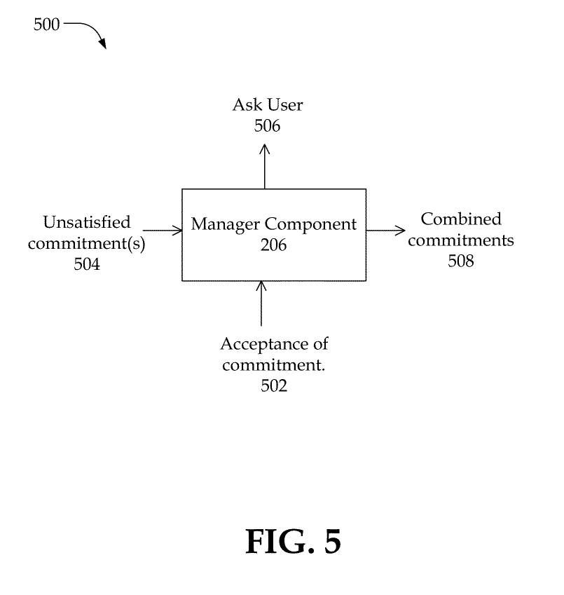

The manager component 206 can manage information regarding a commitment of a user of the loyalty program. The information can include the amount of money to be spent at a merchant or plurality of merchants, a deadline to spend the information, and information related to an account of the user from which to deduct an amount of a discount previously received if the commitment is not satisfied. The manager component 206 also can function with regard to the acceptance of the commitment. An example operation of manager component 206 is shown in greater detail in FIG. 5.

When a commitment is presented to a user along with a discount received at the point of purchase, the manager component 206 can receive an acceptance of the commitment 502. The manager component 206 can add the commitment to the loyalty program account. In the process of adding the commitment to the loyalty program account, the manager component 206 can examine other unsatisfied commitments 504. The examination can be according to the merchant, an agreement between merchants, a deadline for the outstanding obligation, or any other factor.

The manager component 206 can present an unsatisfied commitment 504 to the user to bundle with the accepted commitment (ask user 506). The bundle can include a portion of the accepted commitment and a portion of the unsatisfied commitment. A user accepted bundle can be referred to as a combined commitment 508.

The combined commitment 504 can extend the deadline of the unsatisfied commitment 504. For example, the deadline of the unsatisfied commitment 504 can be extended to the deadline of the accepted commitment or both deadlines of the unsatisfied commitment 504 and the accepted commitment can be extended to another date in the future. (or the deadline of the combined commitment 508). Additionally, paths and notifications regarding the combined commitment 508 can be generated by the path component 208 and the notification component 210, respectively.

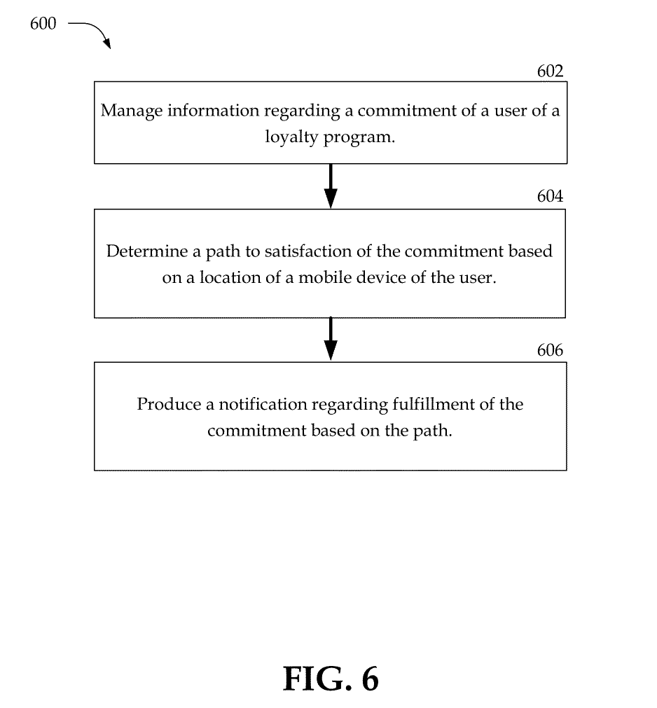

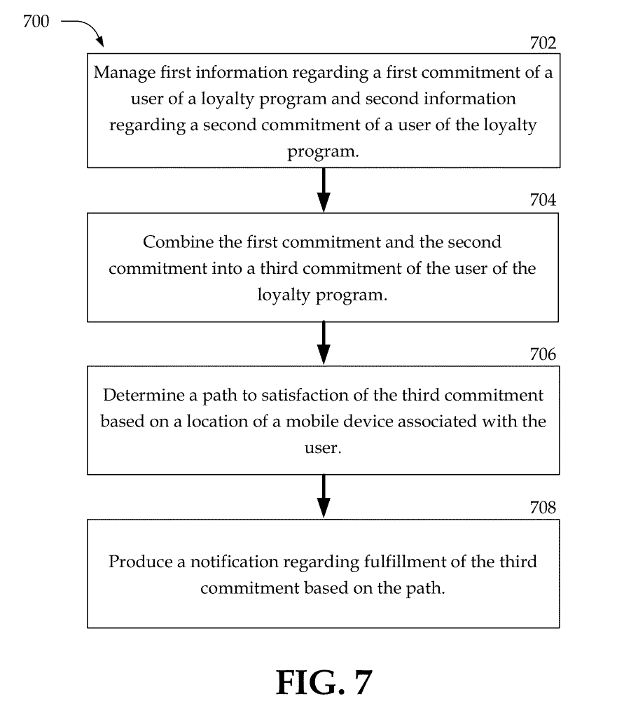

FIGS. 6 and 7 illustrate methods 600 and 700 that facilitate satisfaction of an obligation, commitment or requirement in connection with a discount received via a loyalty program. For simplicity of explanation, the methods (or algorithms) are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a computer readable storage medium, a computer readable device, or the like) to facilitate transporting and transferring such methodologies to computers. The term article of manufacture, as used herein, is intended to encompass a computer program accessible from any computer-readable device, carrier, or media, including a non-transitory computer readable storage medium. Any reference to a data store below can refer to a data store stored in a cloud computing environment. Additionally, all or part of the acts and/or steps described below can occur as a service distributed in a cloud computing environment.

Referring now to FIG. 6, illustrated is a schematic process flow diagram of a method 600 that can facilitate determination of a path to fulfill an obligation related to a discount received in connection with a loyalty program, in accordance with various aspects described herein. At element 602, information regarding a commitment of a user of a loyalty program is managed. At element 604, a path to satisfaction of the commitment can be determined based on a location of a mobile device of the user. At element 606, a notification can be produced regarding the fulfillment of the commitment based on the path.

The information regarding the commitment of the user of the loyalty can be include an amount required to spend, an amount currently spent, a deadline, merchant location(s), user account information, and the like. The path can be an easy way to satisfy of the commitment based on a location of a mobile device associated with the user. Notification can instruct the user on the easy way to fulfill the commitment.

The terms “commitment,” “requirement,” and “obligation” generally refer to a contractual obligation in connection with the loyalty program. The user of the loyalty program agrees to the obligation in exchange for a discount at the point of purchase. Generally, the obligation is for future purchases, but the future purchases can also occur at the same time as the discount is awarded. The obligation can include any combination of money that must be spent at any combination of merchants using the loyalty program before expiration of one or more deadlines. In an example, the obligation can be related to an amount of money that must be spent at the merchant granting the discount using the loyalty program before expiration of a deadline. The obligation, in another example, can be related to an amount of money that must be spent at a different merchant that does not grant the discount using the loyalty program before expiration of a deadline.

The notification can show indications of one or more merchants with which the user of the loyalty program has outstanding commitments. The path can illustrate an easy way to satisfy of the one or more outstanding obligations (determined based on the location of the mobile device associated with the user (e.g., determined from geolocation data), locations of the merchants with the outstanding commitments, deadlines associated with the outstanding commitments, priorities associated with the outstanding commitments, and the like). The notification can indicate an amount that needs to be spent at the one or more merchants to satisfy the one or more outstanding obligations, as well as how much has already been spent. For example, the notification can include an amount of time to the deadline, location of one or more merchants, proximity to one or more merchants, and other ways to satisfy the obligation within the deadline. The notification can also include a link to a map that can show the path with regard to the location. Multiple paths to satisfy different obligations can also be shown on the map.

Referring now to FIG. 7, illustrated is a schematic process flow diagram of a method 700 that can facilitate satisfaction of an outstanding obligation, in accordance with various aspects described herein. At element 702, first information regarding a first commitment of a user of a loyalty program and second information regarding a second commitment of a user of the loyalty program are managed. One of the commitments can represent an unsatisfied commitment. The other commitment can represent a newly accepted commitment. At element 704, the first commitment and the second commitment can be combined as a third commitment of the user of the loyalty program. The combined commitment can extend the deadline associated with the unsatisfied commitment. At element 706, a path to satisfaction of the third commitment can be determined based on a location of a mobile device associated with the user. At element 708, a notification can be produced regarding fulfillment of the third commitment based on the path.

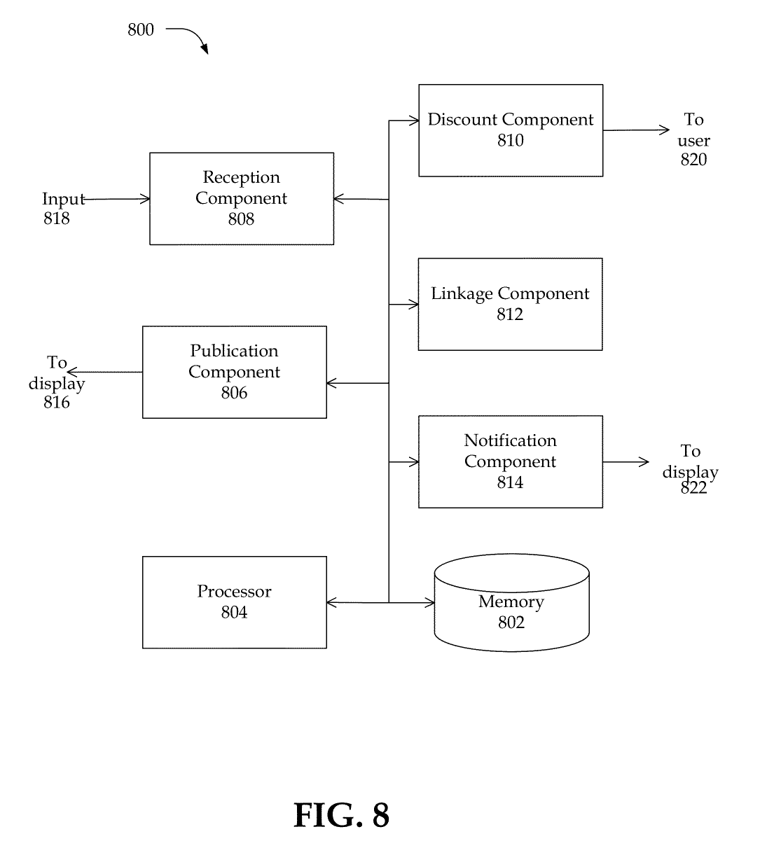

Referring now to FIG. 8, illustrated is a schematic block diagram of a system 800 that can facilitate a user's registration for a discount and commitment with regard to a loyalty program, in accordance with various aspects described herein. System 800 includes a memory 802 that can store instructions, components, or the like. System 800 also includes a processor 804 that can facilitate execution of the instructions, components, or the like to facilitate the performance of various operations associated with the instructions, components, or the like. System 800 can be employed as a service that is stored in a cloud computing environment. The memory 802 and processor 804 of system 800 can be associated with a server or distributed across a plurality of servers within the cloud computing system. System 800 can also be a mobile application that is stored and executed on a mobile device. Moreover, system 1500 can be stored in the cloud computing system and executed on the mobile device.

System 800 includes various components that can facilitate a user's registration for the discount and commitment (obligation or requirement) with respect to the loyalty program. The components can include at least a publication component 806, a reception component 808, a discount component 810, a linkage component 812 and a notification component 814. These components can work together to facilitate a user's registration for a discount and associated commitment, as well as facilitate the satisfaction of the commitment.

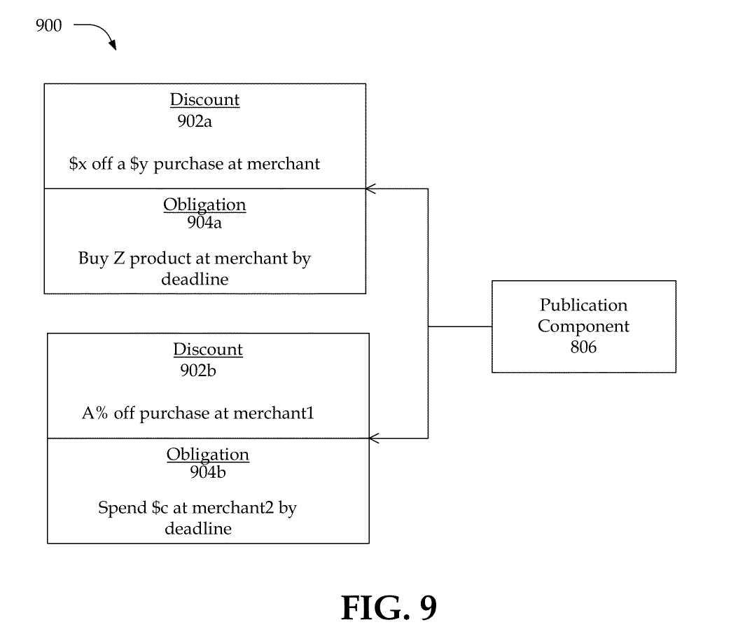

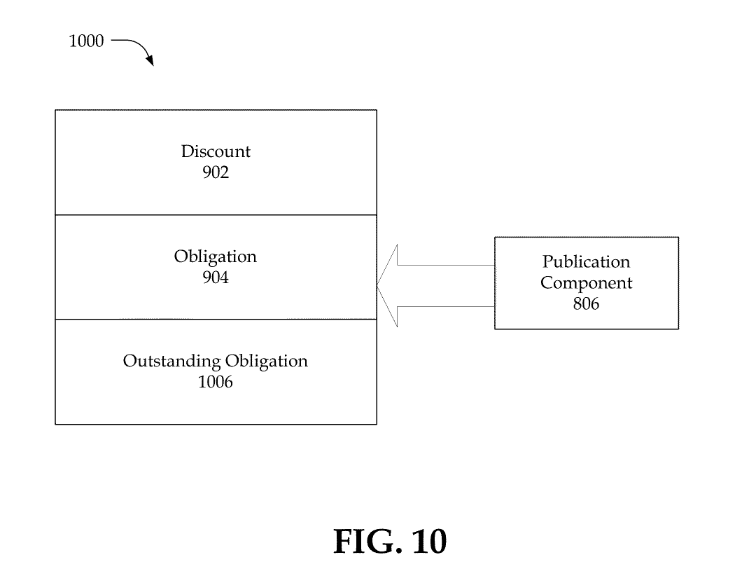

The publication component 806 can publish information related to the discount related to a loyalty program and the required commitment related to the discount. The information can be published, for example, on a display 816 of a mobile device. An example of different display messages with discounts 904a, 904b paired with obligations 904a, 904b is shown in FIG. 9. It will be noted that the obligation does not have to be to the same merchant who grants the discount. Moreover, as illustrated in FIG. 10, the publication can also include the discount 902 and the obligation 904 and information related to an outstanding obligation 1006.

The information can further include a way of accepting the discount and the commitment. The information can also include a way of combining the outstanding obligation 1006 and the obligation 904. Combining obligations 1006 and 904 can extend a deadline associated with the outstanding obligation 1006.

This acceptance can be input 818 to the reception component 808. In other words, the reception component 818 can receive an input from a user accepting the discount and the obligation. The discount and obligation can be associated with the same merchant. The discount and obligation can also be associated with different merchants (e.g., according to an agreement).

The user 808 can be credited with the discount immediately upon acceptance by the discount component 810. After the discount is credited, the linkage component 812 can link the obligation to an account related to the loyalty program and associated with the user. The obligation can be associated with an expiration date (or deadline for completion). If the commitment is not satisfied by the deadline, the account can be accessed and the amount of the discount removed from the account.

To facilitate fulfillment of the commitment, the notification component 814 can produce one or more notifications to the user related to satisfaction of the obligation. For example, the notification can be produced (or published to a display 822 of the mobile device) when the mobile device is in proximity to one or more of the merchants to which the obligation is owed. The proximity can be determined based on geoposition data acquired from the mobile device. For example, geolocation data can be based on global positioning satellite data or triangulation of cellular towers. The notification can further alert the user as to approaching deadlines. For example, notifying the user that, “You only have Y days left to purchase Q from merchant B.” The notification can further associate information about the product or the amount to purchase from the merchant, such as. “Buying product F for the sale price of $Q from merchant B at address (link to map) will satisfy your commitment.”

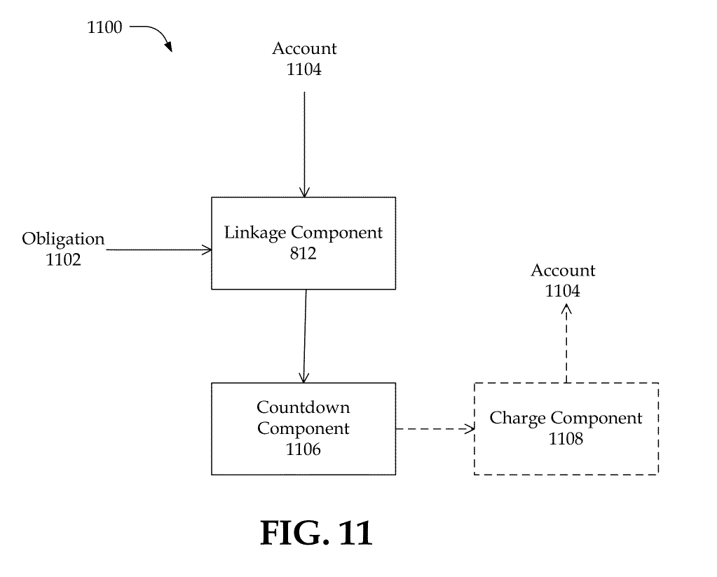

Referring now to FIG. 11, illustrated is a schematic block diagram of a system 1100 that facilitates tracking of a deadline associated with the satisfaction of the obligation associated with the discount, in accordance with various aspects described herein. The obligation 1102 can be linked with an account 1104 of the user by the linkage component 802. The deadline associated with the obligation 1102 can be tracked (or counted down) by the countdown component 1106. If the deadline expires (or the countdown reaches 0), a charge component 1108 can access the account 1104 of the user to deduct the amount of the discount received.

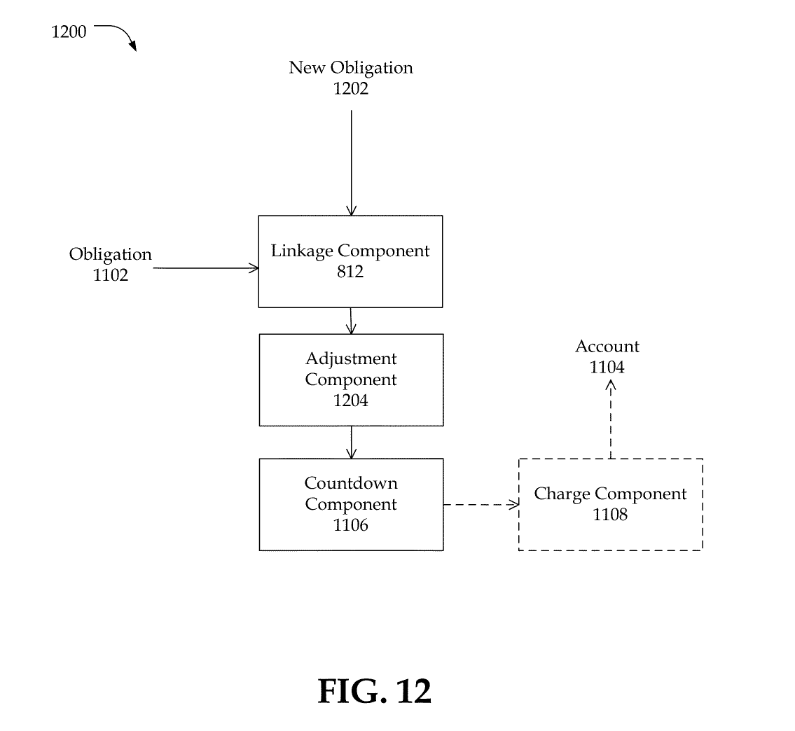

The deadline of the obligation 1102 can be extended when the deadline is being approached. FIG. 12 illustrates a schematic block diagram of a system 900 that can facilitate establishment of a new deadline for an outstanding obligation 1102, in accordance with various aspects described herein. The obligation 1102 can be linked with a new obligation 1202 by the linkage component 812, for example in response to a user accepting a new discount, or in response to an input from the user instructing the linkage component 812 to link the obligation 1102 with the new obligation 1202.

The deadline associated with the obligation 1102 can be extended by the adjustment component 1204 in response to the linkage of the obligation 1102 and the new obligation 1202. For example, the deadline of the obligation 1102 can be extended to a deadline of the new obligation 1102. The deadline of both the obligation 1102 and the new obligation 1202 can also be extended to a new deadline.

The countdown component 1106 can track (or count down) the time until the extended deadline is reached. When the deadline expires (or the countdown reaches 0), the charge component 1108 can access the account 1104 of the user to deduct the amount of the discount received.

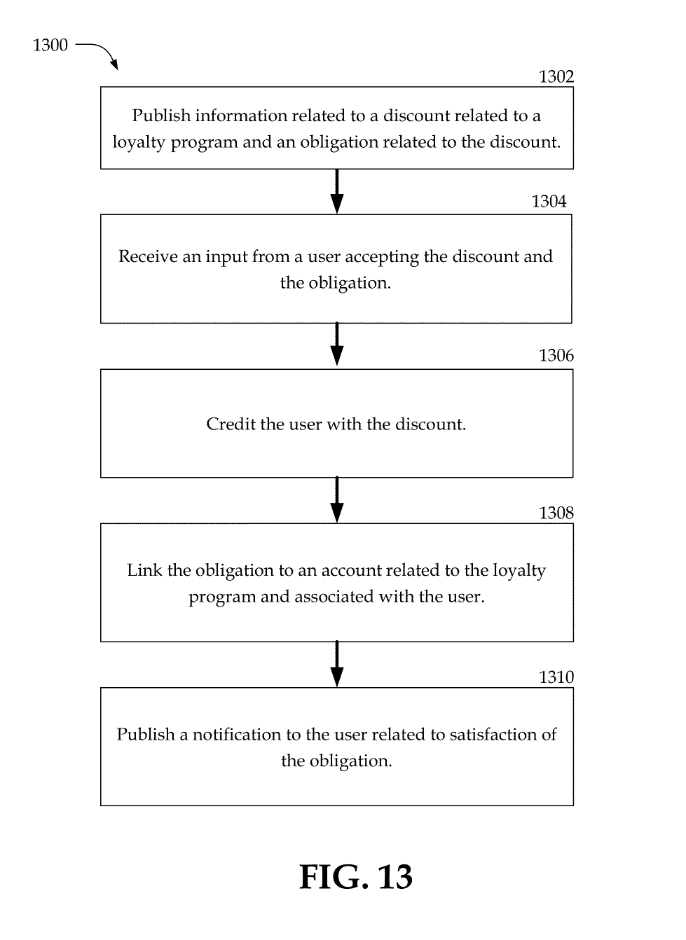

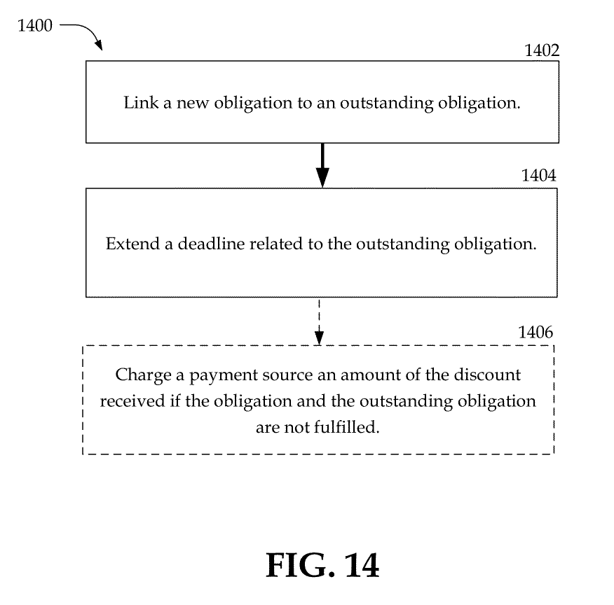

FIGS. 13 and 14 illustrate methods 1300 and 1400 that facilitate satisfaction of an obligation, commitment or requirement in connection with a discount received via a loyalty program. For simplicity of explanation, the methods (or algorithms) are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a computer readable storage medium, a computer readable device, or the like) to facilitate transporting and transferring such methodologies to computers. The term article of manufacture, as used herein, is intended to encompass a computer program accessible from any computer-readable device, carrier, or media, including a non-transitory computer readable storage medium. Any reference to a data store below can refer to a data store stored in a cloud computing environment. Additionally, all or part of the acts and/or steps described below can occur as a service distributed in a cloud computing environment.

Referring now to FIG. 13, illustrated is a schematic process flow diagram of a method 1300 to facilitate a user's registration for a discount and commitment with regard to a loyalty program, in accordance with various aspects described herein. At element 1302, information related to a discount related to a loyalty program and an obligation related to the discount can be published (e.g., as a push notification on a mobile device when the mobile device is in proximity of a location where the discount can be redeemed). The discount and obligation can be associated with the same merchant. The discount and obligation can also be associated with different merchants (e.g., according to an agreement). The information can also include an indication of how to accept the discount and the commitment.

The acceptance can be received at element 1304. When the discount and corresponding commitment are accepted, the user can be credited with the discount at element 1306. The discount can be applied on an immediate purchase. The discount can also be applied to a future purchase.

At element 1308, after the discount is credited, the obligation can be linked to an account related to the loyalty program and associated with the user. The obligation can be associated with an expiration date (or deadline for completion). If the obligation is not satisfied by the deadline, the account can be accessed and the amount of the discount removed from the account.

At element 1310, a notification can be published to the user related to satisfaction of the obligation. The notification can facilitate fulfillment of the obligation\. For example, the notification can be published to a display of the mobile device (as a push notification or an SMS message) when the mobile device is in proximity to one or more of the merchants to which the obligation is owed. The proximity can be determined based on geoposition data acquired from the mobile device. For example, geolocation data can be based on global positioning satellite data or triangulation of cellular towers. The notification can also alert the user of ways to extend the deadline of the obligation (e.g., by accepting an additional obligation).

One such way to extend the obligation is shown in FIG. 14, which illustrates a schematic process flow diagram of a method 1400 that can facilitate extension of a deadline of an outstanding obligation, in accordance with various aspects described herein. Upon receiving an indication of acceptance from the user, at 1402 a new obligation is linked to an outstanding obligation. At 1404, a deadline related to the outstanding obligation is extended. For example, the deadline can be extended to the new deadline of the new obligation. In another example, the deadline can be extended and the new deadline can be extended to a third deadline, further out in time from both the deadline and the new deadline.

A requirement of the extended deadline is that both the obligation and the new obligation must be satisfied. If the obligation and the new obligation are not both satisfied by the extended deadline, at element 1406, a payment source associated with the user can be charged an amount of the discount received. If another discount is received with the new obligation, the account can be charged an additional amount of the new discount. The deadline can be further extended for the combined obligation (or part of the combined obligation) through acceptance of a further obligation.

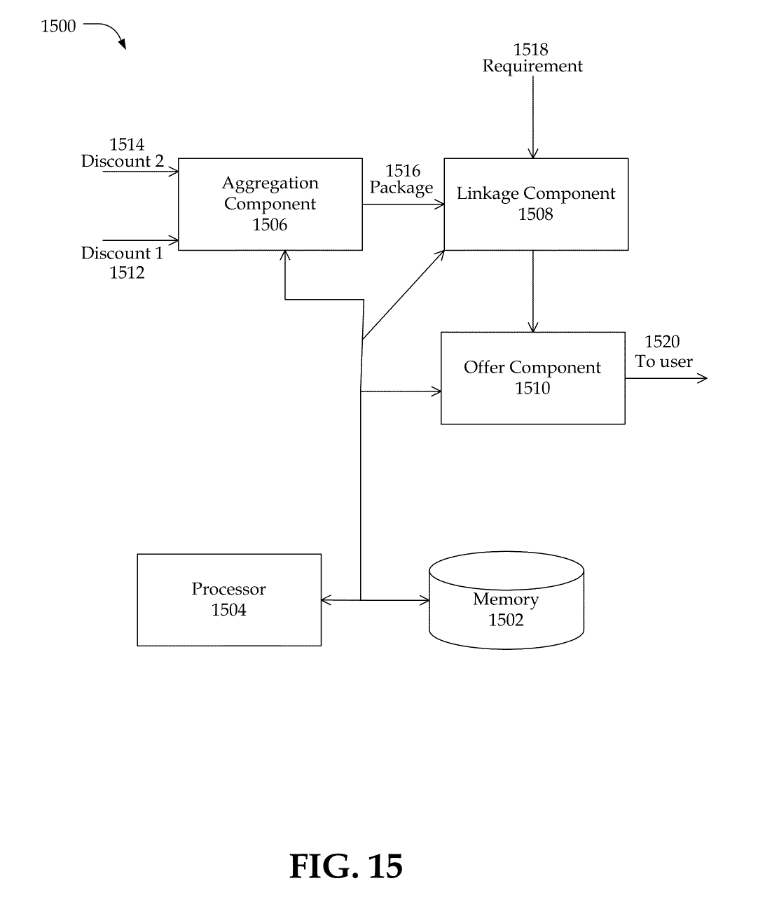

FIG. 15 illustrates a schematic block diagram of a system that facilitates aggregation of different discounts in a package with one or more obligations, in accordance with various aspects described herein. System 1500 includes a memory 1502 that can store instructions, components, or the like. System 1500 also includes a processor 1504 that can facilitate execution of the instructions, components, or the like to facilitate the performance of various operations associated with the instructions, components, or the like. System 1500 can be employed as a service that is stored in a cloud computing environment. The memory 1502 and processor 1504 of system 1500 can be associated with a server or distributed across a plurality of servers within the cloud computing system. System 1500 can also be a mobile application that is stored and executed on a mobile device. Moreover, system 1500 can be stored in the cloud computing system and executed on the mobile device.

System 1500 includes various components that can facilitate aggregation of different discounts in a package with one or more obligations (commitments or requirements) with respect to the loyalty program. The components can include at least an aggregation component 1506, a linkage component 1508 and an offer component 1510. These components can work together to facilitate aggregation of different discounts into a package with one or more obligations.

The aggregation component 1506 can receive information related to a first discount 1512 and information related to a second discount 1514. The first discount 1512 and the second discount 1514 can be combined into a package 1516 by the aggregation component 1506. The aggregation can be based, for example, on a user preference indicated in connection with the loyalty program. The aggregation can be further based on an indication from a merchant that the package will be accepted.

The linkage component 1508 can link the package with a requirement 1518 indicating an amount to be spent (or a product to purchase). The requirement 1518 can be determined based on the first discount and the second discount. For example, the requirement can be to purchase a product in exchange for receiving a discount on a second product and a free third product. If the merchant is a restaurant, the requirement can be to purchase $20 in merchandise by a deadline in exchange for a free small coffee and 20% off a bakery item. The discounts can be immediately credited at the point of sale (in this case, at the restaurant). As another example, the requirement can be an amount to spend at an entirely different merchant. Additionally, the two discounts need not be at the same merchant, nor does the requirement need to be related to a merchant giving the discount.

The offer component 1510 can offer the discounts 1512, 1514 and the linked requirement 1518 to a user 1520 of the loyalty program. The offer can be made, for example, as a push notification or a SMS message when a mobile device associated with the user 1520 is at a location in proximity to at least one of the merchants offering the discount. The proximity can be determined based on geolocation data of the mobile phone (e.g., global positioning satellite data or cellular tower triangulation data).

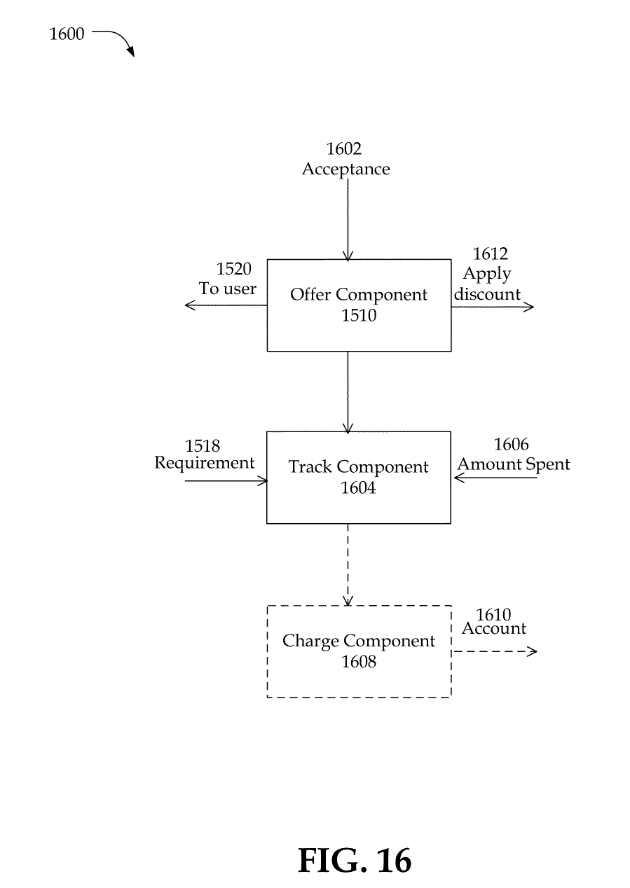

After the acceptance 1602 of the discounts and obligation is received, system 1600 as illustrated in FIG. 16 can track progress in satisfying the obligation, in accordance with various aspects described herein. The offer component 1510 can receive the acceptance 1610. Upon receiving the acceptance 1602, the offer component can facilitate immediate application of the one or more discounts 1612. After the one or more discounts are applied, a track component 1604 can track a requirement 1518 of an amount that must be spent to satisfy the obligation. The track component 1604 can also track an amount spent 1606 to satisfy the requirement 1518. The track component 1604 can also produce notifications of the remaining amount required to satisfy the requirement 1518. The notifications can also be produced in conjunction with an indication of how much was previously saved, so that the user sees exactly how much he is likely to lose without completing the requirement 1518.

If the requirement 1518 is not satisfied by a deadline associated with the requirement 1518, a charge component 1608 can charge the amount previously received to an account 1610 associated with the user. The amount can be a percentage of the discounts received, the entire amount of the discounts received, a percentage of one discount, one entire discount, or any other combination of amounts.

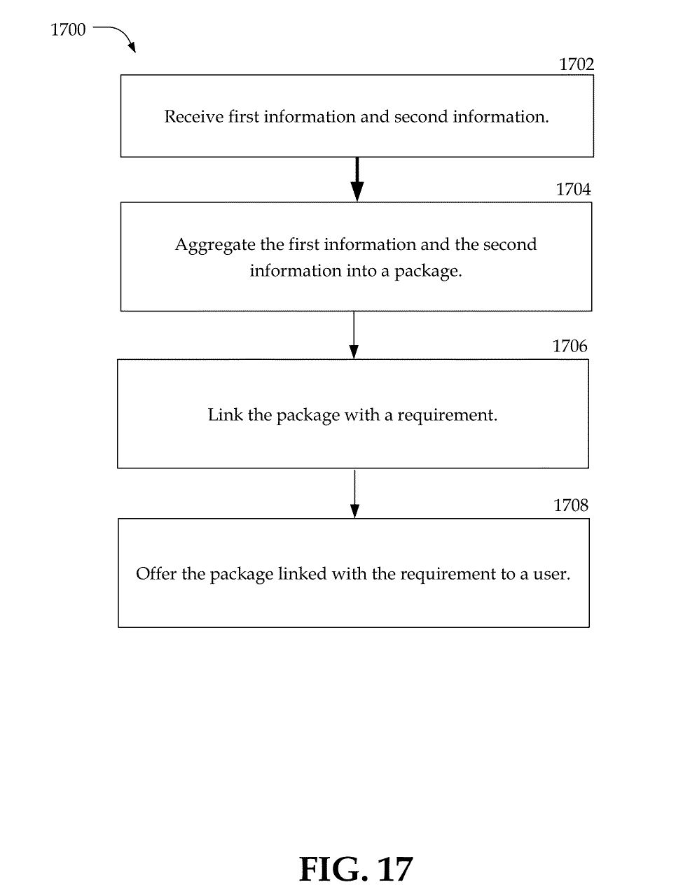

FIGS. 17-19 illustrate methods 1700-1900 that facilitate aggregation of different discounts with respect to a loyalty program. For simplicity of explanation, the methods (or algorithms) are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a computer readable storage medium, a computer readable device, or the like) to facilitate transporting and transferring such methodologies to computers. The term article of manufacture, as used herein, is intended to encompass a computer program accessible from any computer-readable device, carrier, or media, including a non-transitory computer readable storage medium. Any reference to a data store below can refer to a data store stored in a cloud computing environment. Additionally, all or part of the acts and/or steps described below can occur as a service distributed in a cloud computing environment.

Referring now to FIG. 17, illustrated is a schematic process flow diagram of a method 1700 that can aggregation of different discounts in a package with one or more obligations, in accordance with various aspects described herein. At element 1702, first information related to a first discount and second information related to a second discount are received. At element 1704, the first information and the second information can be aggregated into a package. At element 1706, the package can be linked with a requirement. The discounts and the requirement can be at the same merchant, at a combination of different merchants, or any combination of the same merchant and different merchants. At element 1708, the package and the requirement can be offered to a user.

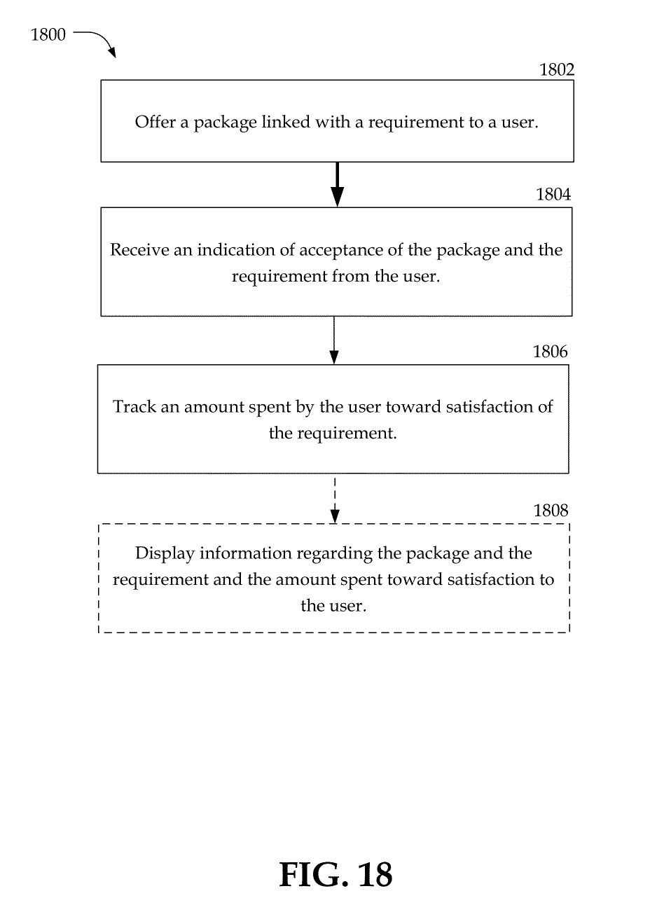

Referring now to FIG. 18, illustrated is a schematic process flow diagram of a method 1800 that can facilitate tracking purchases for satisfaction of a requirement, in accordance with various aspects described herein. At element 1802, a package of two or more discounts linked with a requirement (one or more) can be offered to a user. At element 1804, an indication of acceptance of the package and the requirement can be received from the user. At element 1806, an amount spent by the user toward satisfaction of the requirement can be tracked. At element 1808, optionally, information regarding the package and the requirement, as well as the amount spent toward satisfaction of the requirement can be displayed to the user.

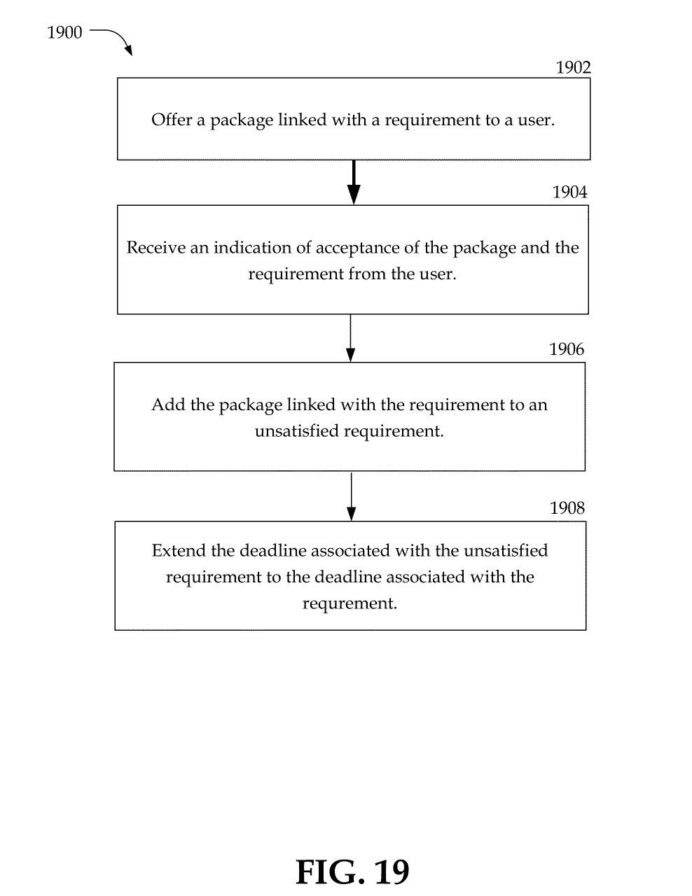

Referring now to FIG. 19, illustrated is a schematic process flow diagram of a method 1900 that can facilitate extension of a deadline of an outstanding obligation, in accordance with various aspects described herein. At element 1902, a package linked with a requirement can be offered to a user. At element 1904, an indication of acceptance of the package and the requirement can be received from the user. At element 1906, the package linked with the requirement can be added to an unsatisfied requirement in response to an acknowledgement by the user. At element 1908, the deadline associated with the unsatisfied requirement can be extended to the deadline associated with the requirement (accepted in connection with the package).

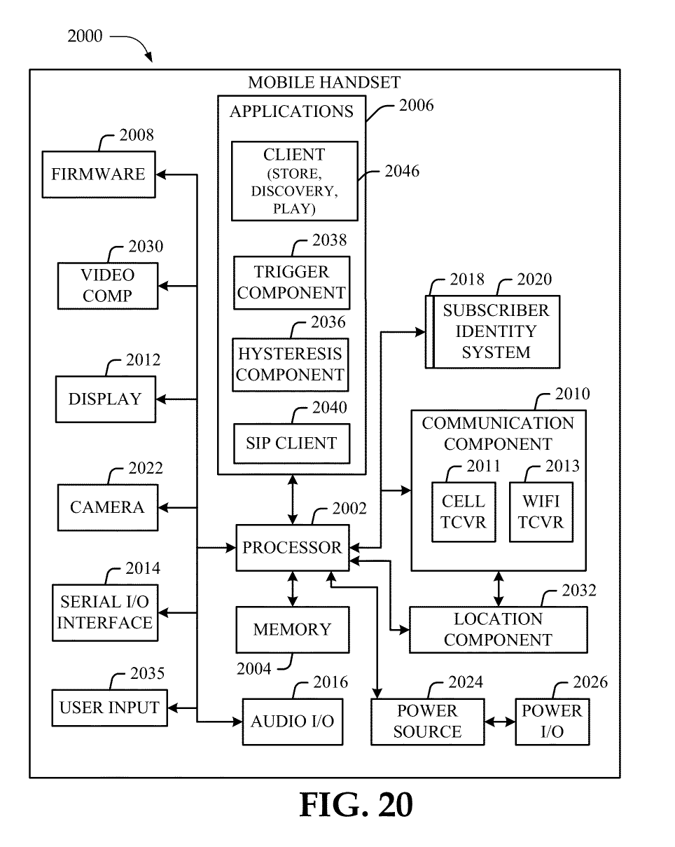

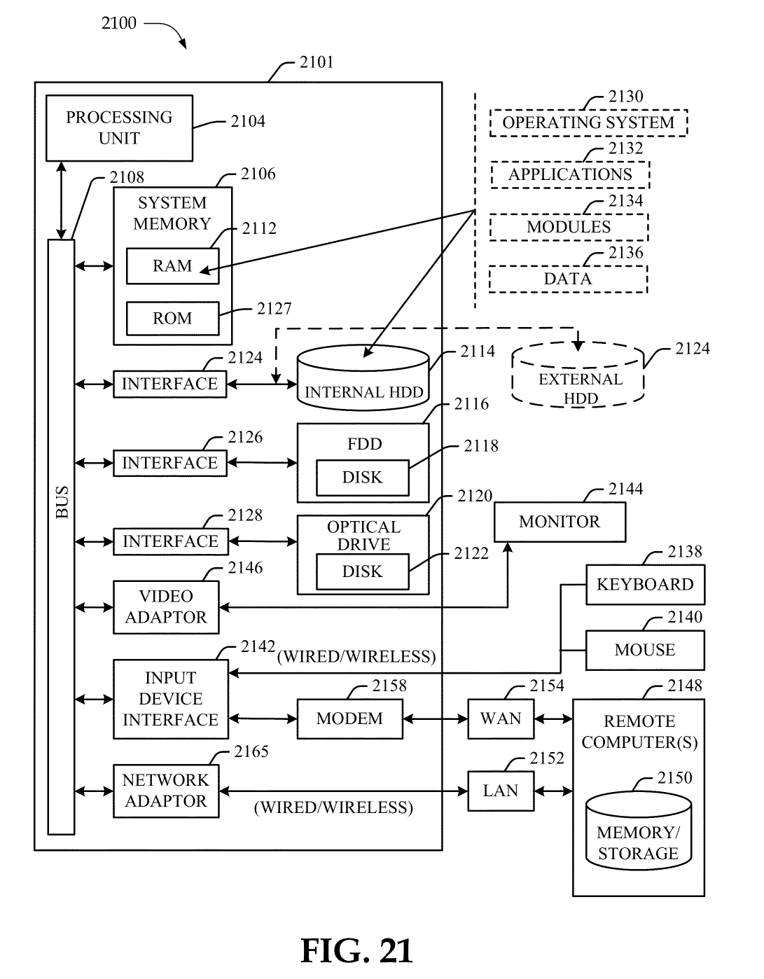

FIGS. 20 and 21 provide examples of different devices that can be used in the storage and execution of the systems and methods described herein. For example, FIG. 20 illustrates a mobile device, similar to element 110 of FIG. 1. Additionally FIG. 22 illustrates a computer, which can be used as a server, for example similar to element 104 of FIG. 1.

Referring now to FIG. 20, illustrated is a schematic block diagram of an exemplary mobile device 2000 capable of executing the mobile applications or services described in accordance with some aspects and embodiments described herein. Although a mobile handset 2000 is illustrated herein, it will be understood that other devices can be a mobile device, and that the mobile handset 2000 is merely illustrated to provide context for the aspects and embodiments of the innovation described herein. The following discussion is intended to provide a brief, general description of an example of a suitable environment 2000 in which the various aspects and embodiments can be implemented. While the description includes a general context of computer-executable instructions embodied on a computer readable storage medium, those skilled in the art will recognize that the innovation also can be implemented in combination with other program modules and/or as a combination of hardware and software.

Generally, mobile computing applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include or interface to a variety of computer-readable media or devices. Computer readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 2000 includes a processor 2002 for controlling and processing all onboard operations and functions. A memory 2004 interfaces to the processor 2002 for storage of data and one or more applications 2006. Other applications can include voice recognition of predetermined voice commands that facilitate initiation of the user feedback signals. The applications 2006 can be stored in the memory 2004 and/or in a firmware 2008, and executed by the processor 2002 from either or both the memory 2004 or/and the firmware 2008. The firmware 2008 can also store startup code for execution in initializing the handset 2000. A communications component 2010 interfaces to the processor 2002 to facilitate wired/wireless communication with external systems, e.g., cellular networks, VoIP networks, and so on. Here, the communications component 2010 can also include a suitable cellular transceiver 2011 (e.g., a GSM transceiver) and/or an unlicensed transceiver 2013 (e.g., WiFi, WiMax) for corresponding signal communications. The handset 2000 can be a device such as a cellular telephone, a PDA with mobile communications capabilities, and messaging-centric devices. The communications component 2010 also facilitates communications reception from terrestrial radio networks (e.g., broadcast), digital satellite radio networks, and Internet-based radio services networks.

The handset 2000 includes a display 2012 for displaying text, images, video, telephony functions (e.g., a Caller ID function), setup functions, and for user input. For example, the display 2012 can also be referred to as a “screen” that can accommodate the presentation of multimedia content (e.g., metadata, messages, wallpaper, graphics, etc.). A serial I/O interface 2014 is provided in communication with the processor 2002 to facilitate wired and/or wireless serial communications (e.g., USB, and/or IEEE 1394) through a hardwire connection, and other serial input devices (e.g., a keyboard, keypad, and mouse). This supports updating and troubleshooting the handset 2000, for example. Audio capabilities are provided with an audio I/O component 2016, which can include a speaker for the output of audio signals related to, for example, indication that the user pressed the proper key or key combination to initiate the user feedback signal. The audio I/O component 2016 also facilitates the input of audio signals through a microphone to record data and/or telephony voice data, and for inputting voice signals for telephone conversations.

The handset 2000 can include a slot interface 2018 for accommodating a SIC (Subscriber Identity Component) in the form factor of a card Subscriber Identity Module (SIM) or universal SIM 2020, and interfacing the SIM card 2020 with the processor 2002. However, it is to be appreciated that the SIM card 2020 can be manufactured into the handset 2000, and updated by downloading data and software.

The handset 2000 can process IP data traffic through the communication component 2010 to accommodate IP traffic from an IP network such as, for example, the Internet, a corporate intranet, a home network, a person area network, etc., through an ISP or broadband cable provider. Thus, VoIP traffic can be utilized by the handset 2000 and IP-based multimedia content can be received in either an encoded or decoded format.

A video processing component 2022 (e.g., a camera) can be provided for decoding encoded multimedia content. The handset 2000 also includes a power source 2024 in the form of batteries and/or an AC power subsystem, which power source 2024 can interface to an external power system or charging equipment (not shown) by a power I/O component 2026.

The handset 2000 can also include a video component 2030 for processing video content received and, for recording and transmitting video content. For example, the video component 2030 can facilitate the generation, editing and sharing of a display regarding outstanding obligations and/or available discounts. A location tracking component 2032 facilitates geographically locating the handset 2000 that can be used to create the paths to satisfaction of the obligations. As described hereinabove, this can occur when the user initiates the feedback signal automatically or manually. A user input component 2034 facilitates the user initiating the quality feedback signal. The user input component 2034 can also facilitate the acceptance of various discounts and obligations. The user input component 2034 can include such conventional input device technologies such as a keypad, keyboard, mouse, stylus pen, and/or touch screen, for example.

Referring again to the applications 2006, a hysteresis component 2036 facilitates the analysis and processing of hysteresis data, which is utilized to determine when to associate with the access point. A software trigger component 2038 can be provided that facilitates triggering of the hysteresis component 2038 when the WiFi transceiver 2013 detects the beacon of the access point. A SIP client 2040 enables the handset 2000 to support SIP protocols and register the subscriber with the SIP registrar server.

The handset 2000, as indicated above related to the communications component 2010, includes an indoor network radio transceiver 2013 (e.g., WiFi transceiver). This function supports the indoor radio link, such as IEEE 802.11, for the dual-mode GSM handset 2000. The handset 2000 can accommodate at least satellite radio services through a handset that can combine wireless voice and digital radio chipsets into a single handheld device.

Referring now to FIG. 21, there is illustrated a block diagram of a computer operable to execute a system architecture that facilitates satisfaction of a commitment in connection with a loyalty program. The computer can provide networking and communication capabilities between a wired or wireless communication network and a server and/or communication device. In order to provide additional context for various aspects thereof, FIG. 21 and the following discussion are intended to provide a brief, general description of a suitable computing environment 2100 in which the various aspects of the innovation can be implemented to facilitate the satisfaction of an obligation. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 21, the exemplary environment 2100 for implementing various aspects described herein includes a computer 2102, the computer 2102 including a processing unit 2104, a system memory 2106 and a system bus 2108. The system bus 2108 couples system components including, but not limited to, the system memory 2106 to the processing unit 2104. The processing unit 2104 can be any of various commercially available processors. Dual microprocessors and other multi processor architectures can also be employed as the processing unit 2104.

The system bus 2108 can be any of several types of bus structure that can further interconnect to a memory bus (with or without a memory controller), a peripheral bus, and a local bus using any of a variety of commercially available bus architectures. The system memory 2106 includes read-only memory (ROM) 2110 and random access memory (RAM) 2112. A basic input/output system (BIOS) is stored in a non-volatile memory 2110 such as ROM, EPROM, EEPROM, which BIOS contains the basic routines that help to transfer information between elements within the computer 2102, such as during start-up. The RAM 2112 can also include a high-speed RAM such as static RAM for caching data.

The computer 2102 further includes an internal hard disk drive (HDD) 2114 (e.g., EIDE, SATA), which internal hard disk drive 2114 can also be configured for external use in a suitable chassis (not shown), a magnetic floppy disk drive (FDD) 2116, (e.g., to read from or write to a removable diskette 2118) and an optical disk drive 2120, (e.g., reading a CD-ROM disk 2122 or, to read from or write to other high capacity optical media such as the DVD). The hard disk drive 2114, magnetic disk drive 2116 and optical disk drive 2111 can be connected to the system bus 2108 by a hard disk drive interface 2124, a magnetic disk drive interface 2126 and an optical drive interface 2128, respectively. The interface 2124 for external drive implementations includes at least one or both of Universal Serial Bus (USB) and IEEE 2194 interface technologies. Other external drive connection technologies are within contemplation of the subject innovation.

The drives and their associated computer-readable media provide nonvolatile storage of data, data structures, computer-executable instructions, and so forth. For the computer 2102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. It is to be appreciated that the innovation can be implemented with various commercially available operating systems or combinations of operating systems.

A user can enter commands and information into the computer 2102 through one or more wired/wireless input devices, e.g., a keyboard 2138 and a pointing device, such as a mouse 2140. Other input devices (not shown) may include a microphone, an IR remote control, a joystick, a game pad, a stylus pen, touch screen, or the like. These and other input devices are often connected to the processing unit 2104 through an input device interface 2142 that is coupled to the system bus 2108, but can be connected by other interfaces, such as a parallel port, an IEEE 2394 serial port, a game port, a USB port, an IR interface, etc.

A monitor 2144 or other type of display device is also connected to the system bus 2108 through an interface, such as a video adapter 2146. In addition to the monitor 2144, a computer typically includes other peripheral output devices (not shown), such as speakers, printers, etc.

The computer 2102 can operate in a networked environment using logical connections by wired and/or wireless communications to one or more remote computers, such as a remote computer(s) 2148. The remote computer(s) 2148 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2150 is illustrated. The logical connections depicted include wired/wireless connectivity to a local area network (LAN) 2152 and/or larger networks, e.g., a wide area network (WAN) 2154. Such LAN and WAN networking environments are commonplace in offices and companies, and facilitate enterprise-wide computer networks, such as intranets, all of which may connect to a global communications network, e.g., the Internet.

When used in a LAN networking environment, the computer 2102 is connected to the local network 2152 through a wired and/or wireless communication network interface or adapter 2156. The adapter 2156 may facilitate wired or wireless communication to the LAN 2152, which may also include a wireless access point disposed thereon for communicating with the wireless adapter 2156.

When used in a WAN networking environment, the computer 2102 can include a modem 2158, or is connected to a communications server on the WAN 2154, or has other means for establishing communications over the WAN 2154, such as by way of the Internet. The modem 2158, which can be internal or external and a wired or wireless device, is connected to the system bus 2108 through the serial port interface 2142. In a networked environment, program modules depicted relative to the computer 2102, or portions thereof, can be stored in the remote memory/storage device 2150. It will be appreciated that the network connections shown are exemplary and other means of establishing a communications link between the computers can be used.

The computer 2102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated aspects and embodiments, including what is described in the Abstract, is not intended to be exhaustive or to limit the disclosed aspects and embodiments to the precise forms disclosed. While specific aspects and embodiments and examples are described herein for illustrative purposes, various modifications are possible that are considered within the scope of such aspects and embodiments and examples, as those skilled in the relevant art can recognize.

As used herein, the word “example” is used herein to mean serving as an example, instance, or illustration. For the avoidance of doubt, the subject matter described herein is not limited by such examples. In addition, any aspect or design described herein as an “example” is not necessarily to be construed as preferred or advantageous over other aspects or designs, nor is it meant to preclude equivalent structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In this regard, while the described subject matter has been described in connection with various aspects and embodiments and corresponding Figures, where applicable, it is to be understood that other similar aspects and embodiments can be used or modifications and additions can be made to the described aspects and embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims.

What is claimed is:

1. A system, comprising:
a memory to store computer-executable instructions; and
a processor, coupled to the memory, that facilitates execution of the computer-executable instructions to at least:
manage information regarding a commitment of a user of a loyalty program;
determine a path to satisfaction of the commitment based on a location of a mobile device associated with the user; and
produce a notification regarding fulfillment of the commitment based on the path.

2. The system of claim 1, wherein the path includes a purchase at a first merchant utilizing a loyalty card and a purchase at a second merchant utilizing the loyalty card.

3. The system of claim 2, wherein the notification comprises a location of the first merchant or a location of the second merchant with respect to the location of the mobile device.

4. The system of claim 1, wherein the notification is a push notification on the mobile device.

5. The system of claim 1, wherein the information further comprises information regarding a second commitment of the user of the loyalty program.

6. The system of claim 5, wherein the processor further facilitates the execution of the instructions to:
determine a second path to satisfaction of the second commitment based on the location of the mobile device; and
produce a second notification regarding fulfillment of the second commitment based on the second path.

7. The system of claim 5, wherein the processor further facilitates the execution of the instructions to:
combine a portion of the commitment and a portion of the second commitment into a third commitment in response to user input;
determine a third path to satisfaction of the third commitment based on the location of the mobile device associated with the user; and
produce a third notification regarding fulfillment of the third commitment based on the path.

8. The system of claim 1, wherein the processor further facilitates the execution of the instructions to:
receive geoloocation data from the mobile device associated with the user; and
determine the location of the mobile device associated with the user from the geolocation data.

9. A mobile device, comprising:
a memory to store instructions; and
a processor, coupled to the memory, that facilitates execution of the instructions to at least:
publish information related to a discount related to a loyalty program and an obligation related to the discount;
receive an input from a user accepting the discount and the obligation;
credit the user with the discount;
link the obligation to an account related to the loyalty program and associated with the user; and
publish a notification to the user related to satisfaction of the obligation.

10. The mobile device of claim 9, wherein the discount relates to a first merchant and the obligation relates to a second merchant.

11. The mobile device of claim 9, wherein the obligation is linked to an expiration date for completion wherein a bank account associated with the user is charged an amount of the discount when the obligation is not fulfilled by the expiration date for completion.

12. The mobile device of claim 9, wherein the information related to the discount is published with information related an outstanding obligation.

13. The mobile device of claim 12, wherein the processor further facilitates the execution of the instructions to:
link the obligation to the outstanding obligation within the account related to the loyalty program and associated with the user,
wherein the obligation and the outstanding obligation are directed to a common merchant.

14. The mobile device of claim 13, wherein the processor further facilitates the execution of the instructions to extend an expiration date of the outstanding obligation in response to addition of the obligation.

15. The mobile device of claim 9, wherein the processor further facilitates the execution of the instructions to publish a second notification related to an expiration date of the obligation.

16. The mobile device of claim 9, wherein the notification alerts the user that the obligation can be satisfied at a merchant in proximity to the mobile device,
wherein the proximity is determined geoposition determined based on a global positioning satellite or triangulation of cellular towers.

17. A method, comprising:
receiving, by a system comprising a processor, first information related to a first discount from a first merchant and second information related to a second discount from a second merchant;
aggregating, by the system, the first information related to the first discount from the first merchant and the second information related to the second discount from the second merchant into a package;
linking, by the system, a requirement with the package, wherein the requirement is determined based on the first discount and the second discount and the requirement comprises an amount to be spent by a deadline; and
offering, by the system, the package linked with the requirement to a user.

18. The method of claim 17, further comprising:
receiving, by the system, an indication of acceptance of the package linked with the requirement from the user; and
tracking, by the system, an amount spent by the user towards satisfaction of the requirement by the deadline.

19. The method of claim 18, further comprising:
crediting, by the system, the first discount and the second discount to the user upon receiving the indication of acceptance.

20. The method of claim 19, further comprising:
charging, by the system, an account associated with the user the amount of the first discount and the second discount if the requirement remains unsatisfied after expiration of the deadline.

21. The method of claim 17, further comprising:
receiving, by the system, third information related to a third discount from a third merchant;
linking, by the system, the third discount to a second requirement; and
aggregating, by the system, the package linked with the requirement and the third discount linked with the second requirement.

22. The method of claim 17, wherein the requirement further comprises an amount to be spent at a third merchant.

23. The method of claim 17, wherein the offering further comprises:
displaying, by the system, the package and the requirement on a screen of a mobile device.

24. The method of claim 17, further comprising:
receiving, by the system, user input indicating acceptance of the package linked with the requirement;
adding, by the system, the package linked with the requirement to an unsatisfied requirement; and
extending, by the system, a deadline associated with the unsatisfied requirement to a deadline associated with the requirement.

25. A computer readable storage device comprising computer-executable instructions that, in response to execution, cause a system comprising a processor to perform operations, comprising:
offering a discount toward a purchase from a merchant and a requirement to satisfy before expiration of a time period;
receiving an indication of acceptance of the discount and the requirement of an additional amount to be spent from the user;
applying the discount toward the purchase upon receiving the indication of acceptance; and
tracking an amount spent by the user towards satisfaction the additional amount to be spent of the requirement by the deadline.

26. The computer readable storage device of claim 25, wherein the operations further comprise notifying the user of a way to satisfy the requirement.

27. The computer readable storage device of claim 26, wherein the operations further comprise utilizing geolocation information to determine the way to satisfy the requirement.

28. The computer readable storage device of claim 25, wherein the operations further comprise notifying the user of an amount of time left before the deadline.

29. The computer readable storage device of claim 25, wherein the operations further comprise combining the discount and the requirement with a previous requirement for the user.

30. The computer readable storage device of claim 29, wherein the operations further comprise extending a deadline of the previous requirement upon the combining.

31. The computer readable storage device of claim 25, wherein the operations further comprise removing the discount in response to the requirement not being satisfied.

32. The computer readable storage device of claim 31, wherein the removing further comprise charging an account associated with the user an amount of the discount in response to the requirement not being satisfied.
